(19) United States
(12) Patent Application Publication
(10) Pub. No.: US 2026/0042357 A1
(43) Pub. Date: Feb. 12, 2026

(54) A METHOD OF BRAKING A VEHICLE HAVING AN ELECTRIC DRIVE MOTOR, A COMPUTING UNIT, AND A COMPUTER PROGRAM

(71) Applicant: Robert Bosch GmbH, Stuttgart (DE)

(72) Inventors: Joachim Sick, Wiefelstede (DE); Harald Giuliani, Wien (AT); Martin Paces, Wien (AT)

(21) Appl. No.: 18/997,572

(22) PCT Filed: Jun. 26, 2023
(86) PCT No.: PCT/EP2023/067307

§ 371 Date: Jan. 22, 2025

(30) Foreign Application Priority Data
Jul. 27, 2022 (DE) 10 2022 207 688.5

(51) Int. Cl. B60L 15/20

(52) U.S. Cl. CPC B60L 15/2009; B60L 2240/12; B60L 2240/16; B60L 2240/423; B60L 2260/22

(57) ABSTRACT

The invention relates to a method of braking a vehicle (10) having an electric drive motor (14), wherein, in a first braking phase, a target value for a braking torque is specified to the electric drive motor (14), wherein a current speed of the vehicle (10) is sensed as the actual speed, wherein, when the actual speed reaches a threshold value (v₀) for a vehicle speed, the specification of the target value for a braking torque is ended and a speed target trajectory (202) is specified in a second braking phase, wherein the speed target trajectory proceeds from the threshold value (v₀) for the vehicle speed to a speed of zero, and wherein the threshold value (v₀) for the vehicle speed is determined from a current deceleration of the vehicle (10) and a jerk value.

### BACKGROUND

The present invention relates to a method for braking a vehicle with an electric drive motor, as well as a computing unit and a computer program for carrying it out.

Various technical devices are available for braking a vehicle, for example, wheel brakes or electric motors, which are either generator operated so that a braking magnetic field is induced in the coil of the electric motor, or which are selectively energized so that the electric motor is exposed to a torque that slows the vehicle.

Control of electric motors in vehicles is typically based on a target torque as a guide variable. As electric motors can provide both a positive and negative torque regardless of the direction of rotation, in the low speed range, there is the problem of accurately setting a particular position or speed of the electric motor. In this case, it must be ensured that at no time is a torque generated that accelerates the vehicle opposite to a desired direction of movement. If, for example, it is desired that the vehicle decelerate to a stop by means of the electric motor, it must be ensured that no reverse travel initiated by a corresponding torque of the electric motor occurs directly after the stop.

The stopped state of the vehicle is typically detected based on an evaluation of the vehicle speed; the vehicle speed, in turn, is derived from a wheel speed. Incremental encoders are typically used for this purpose, so that the speed signal of the vehicle is only present as a volatile function. Due to this measurement inaccuracy and the fact that latencies are present in the signal processing, the wheel speed is not suitable for use as an input variable for controlling the speed of the vehicle in low speed ranges, in particular at speeds close to zero.

To improve this, DE 10 2019 205 180 A1 presents a method for braking a vehicle comprising an electric drive motor, wherein the vehicle is brought to a standstill using a speed control of the electric drive motor.

### SUMMARY

According to the invention, a method for braking a vehicle using an electric drive motor is proposed, as well as a computing unit and a computer program for carrying it out with the features of the disclosure.

The invention relates in detail to a method for braking a vehicle having an electric drive motor, wherein, in a first braking phase, a target value for a braking torque is specified to the electric drive motor, wherein a current speed of the vehicle is sensed as the actual speed, wherein, when the actual speed reaches a threshold value for a vehicle speed, the specification of the target value for a braking torque is ended and a speed target trajectory is specified in a second braking phase, wherein the speed target trajectory proceeds from the threshold value for vehicle speed to a speed of zero, and whereby the threshold value for vehicle speed is determined from a current deceleration of the vehicle and a jerk value.

In the context of the invention, an improved possibility of braking, in particular stopping a vehicle with an electric drive motor is presented, wherein a speed target value trajectory is determined in a unique way.

It has been shown that a relatively high level of control accuracy must be achieved for a comfortable stopping maneuver. Overshoots at the end of the stopping operation, which can accelerate the vehicle against the desired direction of travel and lead to implausible vehicle behavior for the driver, are particularly critical. Events that occur during the stopping process, such as bumps or obstacles (curbs) are equally problematic. These represent a fault for the controller, which it then attempts to compensate for, which may also be implausible for the driver.

The invention therefore relates in particular—in the context of a stopping process—to the determination of the speed target trajectory. Primary objectives are providing maximum ride comfort and avoiding implausible vehicle behavior. The jerk as the rate of change of acceleration over time is critical to the comfort of a maneuver. The smaller the jerk, the more comfortably the maneuver is perceived by the driver. a constant jerk results in a linear change in acceleration. Conversely, for a given change in acceleration within a fixed time, a linear acceleration curve yields the smallest jerk.

In one embodiment, the threshold value for vehicle speed is determined as a quotient of the square of the current deceleration of the vehicle and twice the jerk value. With this variant, only a few parameters are included in the determination, so that it is very easily implemented.

In one embodiment, the jerk value is a predetermined jerk value. It may be predetermined by the manufacturer, for example, based on comfort aspects. It can also be specified based on vehicle or engine specifications, e.g. a necessary minimum jerk that can be provided by the vehicle.

In one embodiment, the speed target trajectory includes a linear decrease in the deceleration from the current deceleration at the start of the second braking phase to the value zero at a speed of zero. This results in the smallest possible jerk and thus the greatest possible comfort.

If, at a point in time, the actual speed is less than the target speed specified by the speed target trajectory, in one embodiment the target speed is reduced to the actual speed and the speed target trajectory is further traversed from the speed target corresponding to the actual speed. Effective interference compensation can thus be achieved.

In one embodiment, a deceleration target trajectory is determined from the speed target trajectory, and a braking torque pilot value trajectory is calculated and predetermined as a function of the deceleration target trajectory. By means of such a pilot control, the speed controller has to intervene as little as possible for control purposes because the control variable, here a braking torque, is essentially already predetermined by a pilot value.

In one embodiment, the braking torque pilot value trajectory is determined as a function of the target braking torque value at the end of the first braking phase, the current deceleration at the start of the second braking phase, and a stopping torque required at the end of the second braking phase to maintain the vehicle at a speed of zero. In this variant, only a few parameters are included in the determination, so that it is very easily implemented, wherein in particular even a standstill torque is already taken into account and therefore does not have to be readjusted later.

In one embodiment of the disclosure, wherein the braking torque pilot value trajectory proceeds in a linear fashion from the target value for the braking torque at the end of the first braking phase to the standstill torque necessary to maintain a vehicle speed of zero. With this variant, a linear decrease in deceleration in the speed target trajectory can be achieved very easily.

A computing unit according to the invention, e.g., a control device of a vehicle, is configured, in particular in terms of programming, to carry out a method according to the invention.

The implementation of a method according to the invention in the form of a computer program or computer program product comprising program code for carrying out all method steps is advantageous as well, because the associated costs are very low, in particular if an executing control device is also used for other tasks and is therefore already available. Lastly, a machine-readable storage medium is provided, on which a computer program as described above is stored. Suitable storage media or data carriers for providing the computer program are in particular magnetic, optical and electrical memories, such as hard drives, flash memories, EEPROMs, DVDs, etc. Downloading a program via computer networks (Internet, intranet, etc.) is possible, too. Such a download can be wired or cabled or wireless (e.g., via a WLAN, a 3G, 4G, 5G, or 6G connection, etc.).

Further advantages and embodiments of the invention will emerge from the description and the accompanying drawing.

The invention is illustrated schematically in the drawing on the basis of exemplary embodiments and is described in the following with reference to said drawing.

### BRIEF DESCRIPTION OF THE DRAWINGS

FIG. 1 shows a schematic diagram of a vehicle configured to perform an exemplary embodiment of the method according to the invention;

FIG. 2 shows profiles of travel path, vehicle speed, acceleration and jerk in an exemplary stopping operation according to an embodiment of the invention.

FIG. 3 shows profiles of travel path, vehicle speed, acceleration and torque in an exemplary stopping operation according to an embodiment of the invention.

### DETAILED DESCRIPTION

FIG. 1 shows a schematic diagram of a vehicle 10 configured to perform an exemplary embodiment of the method according to the invention. The vehicle 10 comprises a controller 12, which may in particular be the control unit of a power electronics. The vehicle 10 further includes an electric drive motor 14 configured to drive at least one wheel 11 of the vehicle 10. A sensor device 15 is arranged on the electric drive motor 14 such that the sensor device 15 senses and transmits an angular position and/or a speed of the electric drive motor 14 to the controller 12. The controller 12 is in communication with the electric drive motor 14 via a signal line such that the electric drive motor 14 can be regulated and/or controlled by the controller 12.

For example, if a driver wants to bring the vehicle to a standstill, he or she will typically apply a brake. In the context of one embodiment, it is contemplated that the braking operation will be performed using a drive motor 14 as will be described, by way of example below, with reference to the figures in a contiguous and overall manner.

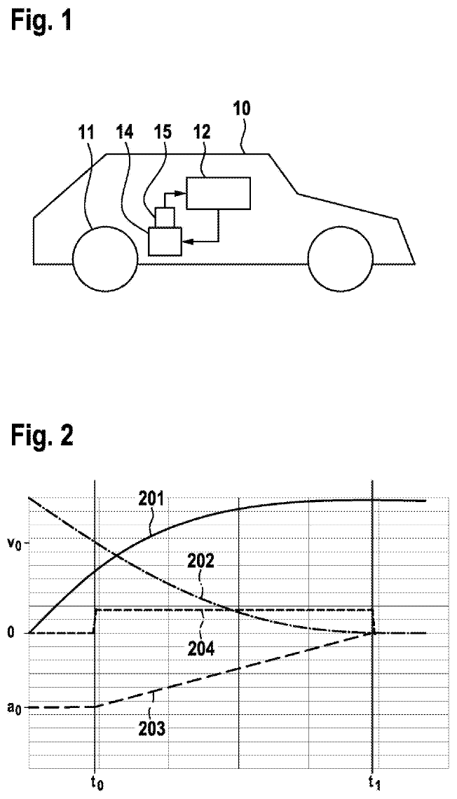

FIG. 2 shows an exemplary stopping operation in the form of a graph in which the travel path and/or position 201, vehicle speed 202, acceleration/deceleration 203, and jerk 204 are shown over time. It can be seen that in a first braking phase up to time to, braking is carried out at a constant deceleration, for example a₀, and is achieved by setting a target value for a braking torque on the electric drive motor.

At time t₀ the speed v₀ is reached as a threshold value for a vehicle speed, which represents the triggering event for the transition to the second braking phase. At this time, a speed target trajectory is determined, as discussed further below, and the drive motor 14 is decelerated to a stop in accordance with this speed target trajectory 202. In particular, this results in a linear decrease of the deceleration 203 to the value zero at speed zero at time t₁.

In the following, a method for calculating the speed target trajectory according to one embodiment of the invention is described.

Based on the vehicle acceleration, a starting speed is calculated at which speed regulation begins. Accordingly, the starting conditions (t-t₀) are:
(t) Initial acceleration
v (t) Initial speed

At the end of the trajectory (t=t₁), the vehicle must come to a standstill. Accordingly, the end conditions are

$$v ( {t}_{0} ) = 0$$

$$v ( {t}_{1} ) = 0$$

Based on the boundary conditions, the course of the speed trajectory over time for a linear decrease in acceleration can be calculated.

The integration of acceleration

$$α ( t ) = k \cdot t + {α}_{0} \qquad ( 1 )$$

leads to speed

$$ν ( t ) = \int α ( t ) dt = \frac{k}{2} {t}^{2} + {α}_{0} t + {ν}_{0} \qquad ( 2 )$$

At the end of the trajectory, both speed and acceleration reach the value 0: t=T: v=0, α=0.

Thus, equation (1) may be converted to

$$0 = k \cdot T + {α}_{0} \qquad ( 3 )$$

Equation (2) becomes

$$0 = \frac{k}{2} {T}^{2} + {α}_{0} T + {ν}_{0} \qquad ( 4 )$$

By combining (3) and (4), the slope k (jerk) may be eliminated, which results in the duration of the trajectory until a standstill is reached:

$$T = - \frac{2 {ν}_{0}}{{α}_{0}} \qquad ( 5 )$$

Now, the equations for acceleration v, speed α, and position x (assuming x (t=0)=0) can be given during the stopping operation.

$$a ( t ) = \frac{{a}_{0}^{2}}{2 {v}_{0}} t + {a}_{0} \qquad ( 6 )$$

$$v ( t ) = \frac{{a}_{0}^{2}}{4 {v}_{0}} {t}^{2} + {a}_{0} t + {v}_{0} \qquad ( 7 )$$

$$x ( t ) = \frac{{a}_{0}^{2}}{12 {v}_{0}} {t}^{3} + \frac{{a}_{0}}{2} {t}^{2} + {v}_{0} t \qquad ( 8 )$$

The jerk k defines how hard or soft stopping feels for the driver. Thus, it is possible to define k as the calibration parameter and thus calculate the entry point of the speed control sequence. In this way, the second braking phase may begin at the point where the acceleration ramp with the slope k precisely leads to a standstill starting from the current acceleration α₀.

Assuming k is defined for the given vehicle, the initial speed may be calculated by eliminating the duration T from the equations.

$${ν}_{0} = \frac{{α}_{0}^{2}}{2 k} \qquad ( 9 )$$

Accordingly, the second braking phase starts when the actual speed reaches the threshold v₀, v≤v₀.

External forces may cause the vehicle to decelerate faster than intended, for example, because it is driving over a bump or curb. In this case, it is advantageous to readjust the trajectory resulting in an overall shorter braking distance. Without this readjustment, the control would counteract the decrease in speed by an acceleration in order to achieve the target values for the original trajectory. The intent is that this be avoided.

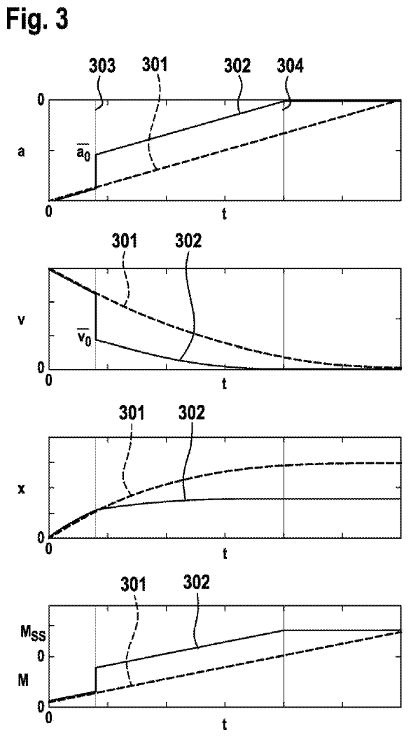

In one embodiment of the invention, therefore, interference correction is provided, as will be described in the following with reference to FIG. 3, in which the progressions of acceleration a, vehicle speed v, travel distance and position x, and torque M are shown in an exemplary stopping operation according to an embodiment of the invention. Progressions 301 without interference are shown as dashed lines, disturbed and corrected paths 302 are shown as solid lines. The time of the interference is marked by line 303. An earlier stopping time due to the interference and readjustment is marked by line 304.

A corresponding procedure is based on the following assumptions:

An interference, such as bump, is detected when, at a given time 303, the actual speed is less than the speed target resulting from the speed target trajectory at that time. In this case, the speed target trajectory is reinitialized with new initial values a₀, v₀, that are present after the interference. However, the acceleration slope k is maintained.

The new initial speed v₀ is equal to the measured speed after the interference. However, it can be assumed that—e.g., due to the numerical differentiation—the measured acceleration signal is noisy after the interference and/or is delayed by the filter and therefore cannot be a₀ used to adjust the new one.

The new initial acceleration results from equation (9)

$$\overline{{α}_{0}} = - \sqrt{2 k \overline{{ν}_{0}}} \qquad ( 10 )$$

Thus, re-initialization corresponds to a time jump on the original speed target trajectory, i.e. if at one time the actual speed is less than the target speed predetermined by the speed target trajectory, the target speed is reduced to the actual speed and the speed target trajectory is continued proceeding from the speed target corresponding to the actual speed.

The interference correction also works for several interferences within the same speed control sequence or even for “continuous” interferences, i.e. if the actual speed is continuously lower than the calculated speed.

In one embodiment of the invention, the specification of a braking torque by way of a pilot control is provided, as shown in the bottom diagram in FIG. 3. Although, in the second braking phase, the drive motor is in a speed control (speed reference value is predetermined, e.g. from a higher-level control unit in the vehicle, such as the so-called VCU or vehicle control unit), the result may be improved by additionally providing a pilot torque.

This is based on the following assumptions:

The pilot torque ₜ is to be:

At the start of the speed control sequence (i.e. at the end of the first braking phase): Target value (_{0,}) for the braking torque at the end of the first braking phase.

At the end of the speed control sequence (i.e. at the end of the second braking phase or at a standstill): equal to a standstill torque required to, for example, compensate for the downhill force. The standstill torque may in particular be estimated by subtracting the derivation of speed from the measured longitudinal acceleration of an inertial sensor.

During speed control: proportional to desired acceleration.

The pilot torque for the drive motor is thus in one embodiment

$${M}_{plt , EM} ( t ) = {M}_{0 , EM} + ( {M}_{SS , EM} - {M}_{0 , EM} ) ( 1 - \frac{a ( t )}{{a}_{0}} )$$

The equation also applies to the correction of interferences. Note only that α₀ and _{0,} the initial values are at the start of the overall speed control sequence and may not be reinitialized in case of a bump.

1. A method of braking a vehicle (10) having an electric drive motor (14),
wherein, in a first braking phase, a target value for a braking torque to the electric drive motor (14) is specified,
wherein a current speed of the vehicle (10) is sensed as the actual speed,
wherein, when the actual speed reaches a threshold value (v₀) for a vehicle speed, the target value for a braking torque is ended and a speed target trajectory (202) is specified in a second braking phase,
wherein the speed target trajectory proceeds from the threshold value (v₀) for the vehicle speed to a speed of zero, and
wherein the threshold value (v₀) for the vehicle speed is determined from a current deceleration of the vehicle (10) and a jerk value.

2. The method of claim 1, wherein the threshold value (v₀) for the vehicle speed is determined as a quotient of the square of the current deceleration of the vehicle (10) and twice the jerk value.

3. The method of claim 1, wherein the jerk value is a minimum jerk greater than zero or a predetermined jerk value provided by the vehicle.

4. The method of claim 1,
wherein the speed target trajectory (202) includes a linear decrease in the deceleration starting from the current deceleration at the start of the second braking phase to the value zero at a speed of zero.

5. The method of claim 1,
wherein, when the actual speed is less than the target speed predetermined by the speed target trajectory (202) at a time, the target speed is reduced to the actual speed and the speed target trajectory (202) is further traversed from the speed target corresponding to the actual speed.

6. The method of claim 1,
wherein a deceleration target trajectory is determined from the speed target trajectory (202), wherein a braking torque pilot value trajectory is calculated and predetermined as a function of the deceleration target trajectory.

7. The method of claim 6, wherein the braking torque pilot value trajectory is determined as a function of the target braking torque value at the end of the first braking phase, the current deceleration at the start of the second braking phase, and a standstill torque (M_{SS}) necessary at the end of the second braking phase to maintain a vehicle (10) speed of zero.

8. The method of claim 7, wherein the braking torque pilot value trajectory proceeds in a linear fashion from the target value for the braking torque at the end of the first braking phase to the standstill torque (M_{SS}) necessary to maintain a speed of zero of the vehicle (10).

9. A computing unit configured to control braking of a vehicle (10) having an electric drive motor by
specifying, in a first braking phase, a target value for a braking torque to the electric drive motor (14),
sensing a current speed of the vehicle (10) as an actual speed,
when the actual speed reaches a threshold value (v₀) for a vehicle speed, ending the target value for a braking torque, and
specifying a speed target trajectory (202) in a second braking phase,
wherein the speed target trajectory proceeds from the threshold value (v₀) for the vehicle speed to a speed of zero, and
wherein the threshold value (v₀) for the vehicle speed is determined from a current deceleration of the vehicle (10) and a jerk value.

10. A computer program that, when executed on a computing unit, causes the computing unit to perform all method steps of a method according to claim 1.

11. A non-transitory, computer-readable storage medium containing instructions that when executed on a computer cause the computer to control braking of a vehicle (10)
having an electric drive motor by
specifying, in a first braking phase, a target value for a braking torque to the electric drive motor (14),
sensing a current speed of the vehicle (10) as an actual speed,
when the actual speed reaches a threshold value (v₀) for a vehicle speed, ending the target value for a braking torque, and
specifying a speed target trajectory (202) in a second braking phase,
wherein the speed target trajectory proceeds from the threshold value (v₀) for the vehicle speed to a speed of zero, and
wherein the threshold value (v₀) for the vehicle speed is determined from a current deceleration of the vehicle (10) and a jerk value.
